(19) United States
(12) Patent Application Publication
(10) Pub. No.: US 2001/0035259 A1
(43) Pub. Date: Nov. 1, 2001

(54) Embedded and bonded transverse attachment for sandwich structure

(75) Inventors: Walter M. Franklin III, Canyon Country, CA (US); David A. Hooke, Palmdale, CA (US)

Correspondence Address: Robert A. Schruhl, 1011 Lockheed Way, Palmdale, CA, 93599-2191, US

(73) Assignee: Lockheed Martin Corporation

(21) Appl. No.: 09/861,995

(22) Filed: May 21, 2001

Related U.S. Application Data
(63) Continuation-in-part of application No. 09/374,303, filed on Aug. 16, 1999, now abandoned.

(51) Int. Cl. B32B 1/00

(52) U.S. Cl. 156/257

(57) ABSTRACT

Disclosed is a method and apparatus for applying large or pull-off loads to a base sandwich panel structure through a wide range of temperatures, including cryogenic temperatures. The apparatus comprises a “+” shaped connector having a vertical leg and laterally extending horizontal legs. The lower portion of the vertical leg is secured in a slot formed in the base sandwich panel structure, while the horizontal legs are secured to a major surface of the base sandwich panel structure adjacent the slot. A load application member is then secured to the upper portion of the vertical leg. The vertical leg facilitates the transfer of loads to or from the base sandwich panel member and the laterally extensive horizontal legs facilitate peel-off shear loads to be distributed through the major surface of said panel.

### CROSS REFERENCE TO RELATED APPLICATIONS

This application is a continuation in part of U.S. patent application Ser. No. 09/374,303, filed Aug. 16, 1999, to Franklin et al.

### BACKGROUND OF THE INVENTION

1. Field of the Invention

The present invention relates to connector-less attachments for structural members, and more particularly to a connection between a base substrate of sandwich construction and a load supporting “take-off” member, where large transverse loads can be applied to the base substrate for a wide range of service temperatures, including cryogenic temperatures.

2. Description of the Related Art

Structural connections between a sandwich or honeycomb substrate and another structural member are well known in the prior art. As an example, U.S. Pat. No. 4,671,470 to Jonas discloses a connection between sandwich skin panels and aircraft frame elements using an “H”-shaped woven composite connector. A groove is formed in the panel, and lateral extensions of the connector mid-portion are positioned over adjacent lateral surface regions of the substrate. A structural foam filler is positioned between the lower leg portions of the connector before it is inserted in the groove in the panel. After being positioned in the panel groove, the connector is secured using a bonding agent. The structural foam filler serves the purpose of backing up the connector legs to insure that they make broad area contact with the walls of the groove and enhancing its ability to transfer the shear load across the groove.

Other devices for transferring loads to and from sandwich panel structures include those taught by U.S. Pat. No. 4,800,643 to Higgins (teaches a method for mounting a fastener in a sandwich panel to support a bolt for holding auxiliary structures to the panel), and U.S. Pat. No. 5,093,957 to Do and U.S. Pat. No. 4,981,735 to Rickson (both teach mounting upper and lower disks with colinear bores in a sandwich panel for the purpose of attaching external structure to the panel via the bores). Other similar devices are disclosed by U.S. Pat. No. 3,510,916 to Phelan, U.S. Pat. No. 3,892,099 to Worgan et al., and U.S. Pat. No. 3,305,996 to Shapiro.

The cruciform of the present invention facilitates easier installation into the sandwich panel as compared with existing art technologies. Installation of the cruciform requires only cutting a slot through the facesheet and core of the sandwich panel. This slot can accomplish in a single cutting operation that can be performed after the sandwich structure is fabricated. Cutting the slot after the sandwich structure is fabricated provides the flexibility to accurately locate the cruciform on the sandwich panel at a later stage in the assembly process, thereby reducing the effect of assembly and manufacturing tolerance buildup.

By comparison, Jonas, U.S. Pat. No. 4,671,470, discloses a design which requires that a finite-width strip of facesheet and core be removed from the sandwich panel to form a groove for installing the H-shaped connector, or that a groove be prefabricated into the sandwich panel. Removing a strip of core to form a groove is difficult because removal requires that the core strip be severed from the inner facesheet. This operation increases the risk of damage to the inner facesheet. Prefabricating a groove into the panel significantly increase the complexity of the sandwich panel tooling and manufacturing process and greatly reduces the capability of the design to accommodate the buildup of manufacturing and assembly tolerances.

The present invention avoids these drawbacks and difficulties as herein described.

Against this background, the applicant has developed a novel apparatus and method for securing a structural member to a sandwich panel that will allow transverse take-off loading through the fastener.

### OBJECTS AND SUMMARY OF THE INVENTION

It is therefore an object of the present invention to provide a novel arrangement for connecting a structural member to a sandwich panel that will allow transverse take-off loading without damaging the sandwich panel, while overcoming many of the disadvantages and drawbacks of similar apparatus known in the art.

Another object of the present invention is to provide a novel method for attaching a structural pull-off member to a sandwich panel by distributing load through shear into the core of the sandwich panel in addition to distributing flatwise tension.

Still another object of the present invention is to provide a novel arrangement for attaching a load take-off member transversely to an underlying sandwich panel base which entails cutting a slot in the base panel, inserting and securing a connector in the slot, and then securing the take-off member to the connector.

Other objects, advantages and features of the invention will become more apparent, as will equivalent structures, which are intended to be covered herein, with the teaching of the principles of the invention in connection with the disclosure of the preferred embodiments thereof in the specification, claims and drawings in which

### BRIEF DESCRIPTION OF THE DRAWINGS

FIG. 1 depicts a cross-sectional view of a structure formed according to the technique of the present invention described hereinafter.

### DETAILED DESCRIPTION OF THE INVENTION

The following description is provided to enable any person skilled in this or any related arts to make and use the present invention, and sets forth the best modes contemplated by the inventor of carrying out his invention. Various modifications, however, will remain readily apparent to those skilled in the art, since the generic principles of the present invention have been defined herein specifically to provide a novel connection and method of connecting a structural member to an underlying sandwich panel that encompasses many long sought after features that make such connections extremely easy and far less expensive to fabricate.

The present invention embraces a technique for securing a load transfer or take-off member to a base sandwich panel which will allow large transverse or “pull-off” loads to be applied or transmitted to the base panel while distributing “peel-off” loads across the skin of the sandwich panel, through a wide range of temperatures, including cryogenic temperatures.

Prior techniques use “wet-layups” or precured and bonded “Pi” clips, “T clips” or H-shaped connectors to introduce loads to the adjacent facesheet of the base sandwich structure. Large peel-off loads quickly cause adhesives to fail. Cryogenic applications suffer because of loss of ductility in the adhesive resulting in lower pull strength.

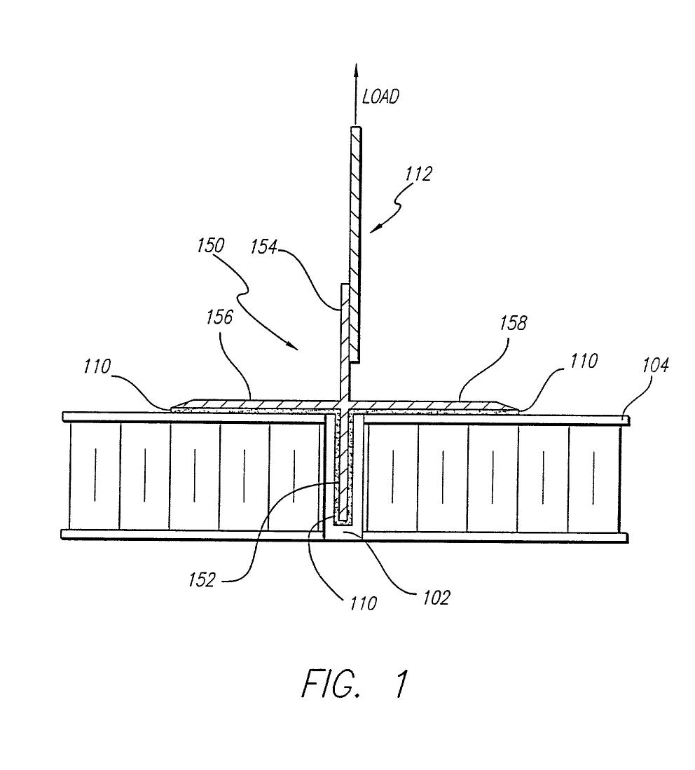

The present invention overcomes the drawbacks of the known techniques through the arrangement shown in FIG. 1 of the drawings, in which a slot or groove 102 is cut or formed in a base sandwich panel structure 104, and a woven composite preform 150 is inserted and secured within the slot or groove via adhesive 110 which is applied to all surfaces of the preform that contact the base structure 104.

The preform 150 preferably has the configuration of a “+” sign, and includes a first leg 152 which is adapted to be disposed in the panel slot 102, a second leg 154 extending coextensive with the first leg adapted to be connected to a take-off member 112, and third and fourth legs 156, 158 which extend laterally of and normal to the first and second legs. The third and fourth legs of the connector are adapted to be connected to the skin of the panel member to transmit shear loading thereto.

The slot 102 is required to be cut into the facesheet and core of the base sandwich panel to allow insertion of the first leg 152 into the core. This leg is bonded to the core to provide a means to transfer transverse pull-off loads into the core. The advantage is that the slot 102 can be cut in a single operation after the base sandwich is fabricated. The single cutting operation reduces manufacturing complexity. Performing the cut after the panel is fabricated and installed avoids the build-up of assembly tolerances and increases the accuracy of locating the woven composite perform 150.

The load transfer or take-off member 112 can be a panel or beam element, and is secured by bonding or bolting to the preform to introduce pull-off loads. Once the slot or groove has been formed in the base panel, attachment of the preform acts as a bonded doubler so that structural strength is not dramatically reduced by cutting the slot. The woven preform allows for load transfer through the intersection of the legs of the preform. It is contemplated that the thermal expansion coefficients of the facesheet and the preform can be matched.

In this manner, the present invention permits distribution of load through shear into the core of the sandwich panel base in addition to flatwise tension. The horizontal leg of the woven preform has bending stiffness, which reduces peel loading.

Those skilled in the art will appreciate that various adoptions and modifications of the invention as described above can be configured without departing from the scope and spirit of the invention. Therefore, it is to be understood that, within the scope of the appended claims, the invention may be practiced other than as specifically described herein.

What I claim is:

1. A method for securing a structural member to a base panel, comprising:
cutting a slot in said base panel,
attaching a woven composite preform in said slot, and
attaching a load transfer member to said preform,
said preform having a horizontal portion and a vertical portion, said vertical portion being arranged in said slot and said horizontal portion being disposed adjacent a major surface of said panel.

2. The method of claim 1, wherein said step of attaching a woven composite preform in said slot includes applying adhesive to surfaces of said preform horizontal and vertical portions which are arranged adjacent to corresponding surfaces of said base panel.

3. The method of claim 1, wherein said step of attaching a woven composite preform in said slot includes securing the horizontal portions to said major surface of said panel.

4. Apparatus for transferring loads to or from a base structural panel, comprising:
a “+” shaped preform including a single vertical leg secured in a slot in said panel and laterally extensive horizontal legs secured in overlying relationship to a major surface of said panel,
whereby said vertical leg enables loads to be transferred to or from said panel and said laterally extensive legs enable peel-off loads to be distributed through the major
